(19) United States
(12) Patent Application Publication
(10) Pub. No.: US 2011/0179293 A1
(43) Pub. Date: Jul. 21, 2011

(54) APPARATUS AND METHOD FOR SYSTEM RESET USING ETHERNET FRAME IN WIRELESS COMMUNICATION SYSTEM

(75) Inventor: Young-Sik Ma, Anyang-si (KR)

(73) Assignee: SAMSUNG ELECTRONICS CO., LTD., Suwon-si (KR)

(21) Appl. No.: 13/006,991

(22) Filed: Jan. 14, 2011

(30) Foreign Application Priority Data
Jan. 15, 2010 (KR) 10-2010-0003672

(51) Int. Cl. G06F 1/26

(52) U.S. Cl. 713/310

(57) ABSTRACT

A Base Station (BS) includes an apparatus capable of performing a system reset using an Ethernet frame. The BS includes an Ethernet switch, a Programmable Logic Device (PLD), and a power unit. The Ethernet switch sorts an Ethernet frame capable of including a power reset command. The PLD attempts to detect a reset pattern at the Ethernet frame capable of including the power reset command, and determines the generation or non-generation of the power reset command depending on the detection or non-detection of the reset pattern. The power unit resets a power of a BS if the generation of the power reset command is notified from the PLD.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Jan. 15, 2010 and assigned Serial No. 10-2010-0003672, the entire disclosure of which is hereby incorporated by reference.

### TECHNICAL FIELD OF THE INVENTION

The present invention relates to a wireless communication system. More particularly, the present invention relates to an apparatus and method for system reset in a wireless communication system.

### BACKGROUND OF THE INVENTION

Presently, a wireless communication system uses an E1/T1 link, an Ethernet link, a wireless link, and the like, as a backhaul link for communication among a Base Station System (BSS), a Radio Network Controller (RNC), and an Element Management System (EMS). In addition, an enterprise network mainly employs Ethernet as a communication interface. Recently, the backhaul link is converting from the existing E1/T1 link to fast Ethernet and Gigabit Ethernet due to an increase of a backhaul capacity of mobile Worldwide Interoperability for Microwave Access (WiMAX), Long Term Evolution (LTE), and 4^{th} generation networks.

In case that a backhaul link normally operates but a normal service is impossible because a Base Station (BS) or system enters an abnormal situation during system operation, a remote system reset is needed. Generally, BSs are installed in places in which man's approach is difficult, such as on a building rooftop, a tower, a mountain region, and the like. Accordingly, in case of an abnormal situation of a system, a man has to visit the scene in person and take care of it, because of an inability to perform power reset. This leads to the consumption of a considerable time, and the incurrence of a cost. Also, during the manual reset, a service is stopped, causing user's inconvenience and dissatisfaction.

Thus, there is a need for an alternative for making system reset possible, despite no personal visit, for a BS making use of Ethernet as a backhaul link.

### SUMMARY OF THE INVENTION

To address the above-discussed deficiencies of the prior art, it is a primary aspect of the present invention to address at least the above mentioned problems and/or disadvantages and to provide at least the advantages described below. Accordingly, an aspect of the present invention is to provide an apparatus and method for resetting a Base Station (BS) that has entered an abnormal state in a wireless communication system.

Another aspect of the present invention is to provide an apparatus and method for remotely resetting a BS using Ethernet as a backhaul link in a wireless communication system.

The above aspects are achieved by providing an apparatus and method to perform a system reset using an Ethernet frame in a wireless communication system.

According to one aspect of the present invention, a BS apparatus in a wireless communication system is provided. The apparatus includes an Ethernet switch, a Programmable Logic Device (PLD), and a power unit. The Ethernet switch sorts an Ethernet frame capable of including a power reset command. The PLD attempts to detect a reset pattern at the Ethernet frame capable of including the power reset command, and determines the generation or non-generation of the power reset command depending on the detection or non-detection of the reset pattern. The power unit resets a power of a BS if the generation of the power reset command is notified from the PLD.

According to another aspect of the present invention, an operation method of a BS in a wireless communication system is provided. The method includes sorting an Ethernet frame capable of including a power reset command, attempting to detect a reset pattern at the Ethernet frame capable of including the power reset command, determining the generation or non-generation of the power reset command depending on the detection or non-detection of the reset pattern, and, if it is determined that the power reset command is generated, resetting a power of the BS.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a construction of an Ethernet frame according to an exemplary embodiment of the present invention;

FIG. 2 illustrates a construction of a Base Station (BS) in a wireless communication system according to an exemplary embodiment of the present invention;

FIG. 3 illustrates a structure of connection between an Ethernet switch and a Programmable Logic Device (PLD) in a wireless communication system according to an exemplary embodiment of the present invention; and

FIG. 4 illustrates a reset procedure of a BS in a wireless communication system according to an exemplary embodiment of the present invention.

Throughout the drawings, like reference numerals will be understood to refer to like parts, components and structures.

### DETAILED DESCRIPTION OF THE INVENTION

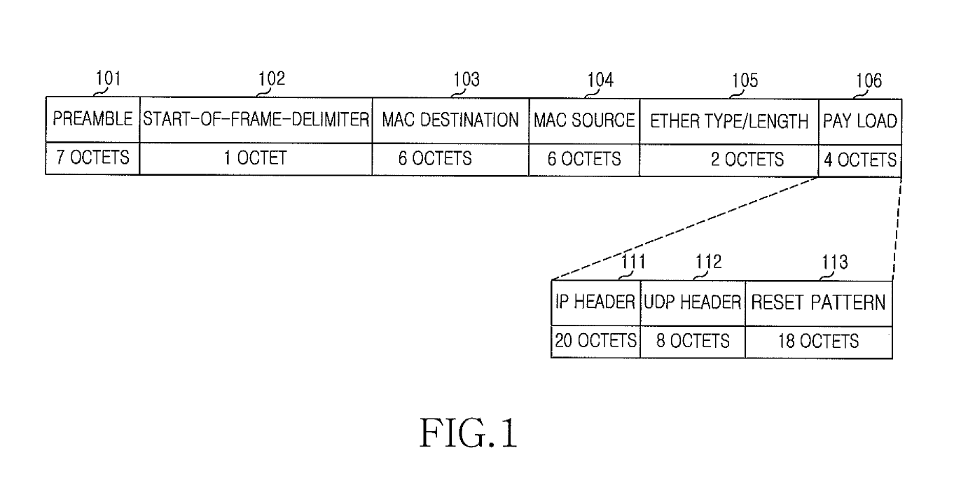

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

A technology for remotely resetting a Base Station (BS) that makes use of Ethernet as a backhaul link according to the present invention is described below.

The present invention resets a BS using an Ethernet frame. That is, a user controls a power unit in person through the Ethernet frame while excluding a processor through remote control, because a processor cannot receive a normal command due to its malfunction.

FIG. 1 illustrates a construction of an Ethernet frame according to an exemplary embodiment of the present invention.

As illustrated in FIG. 1, the Ethernet frame includes a preamble 101, a frame start delimiter (Start-of-Frame-Delimiter) 102, a Media Access Control (MAC) destination 103, a MAC source 104, an Ethertype/Length 105, and a payload 106.

The preamble 101 and the frame start delimiter 102 are a predefined sequence informing a start of the Ethernet frame. The remaining portions excepting the preamble 101 and the frame start delimiter 102 are a MAC frame. BS reset according to an exemplary embodiment of the present invention is performed using a fixed MAC frame of a size of 60 bytes.

The MAC destination 103 represents a MAC address of a destination to receive a MAC frame, and the MAC source 104 represents a MAC address of a source transmitting the MAC frame. The Ethertype/length 105 represents the type and length of an upper protocol included in the payload 106. The payload 106 includes data of the upper protocol, and the like. At this time, in case that the MAC frame is a MAC frame for BS reset, the payload 106 includes an Internet Protocol (IP) header 111 of a size of 20 bytes, a User Datagram Protocol (UDP) header 112 of a size of 8 bytes, and a reset pattern 113 of a size of 18 bytes. The IP header 111 includes an IP address of a BS intended to be reset. The UDP header 112 includes a UDP port number predefined for reset. The reset pattern 113 is set to a bit stream of a specific value. The specific value can be different according to a detailed exemplary implementation. For example, the reset pattern 113 can be ‘0xDB’. However, as one example, the reset pattern 113 illustrated in FIG. 1 can have a different length not the 18 bytes.

A construction and operation procedure of a BS performing reset using the Ethernet frame of FIG. 1 according to the present invention are described below with reference to the drawings.

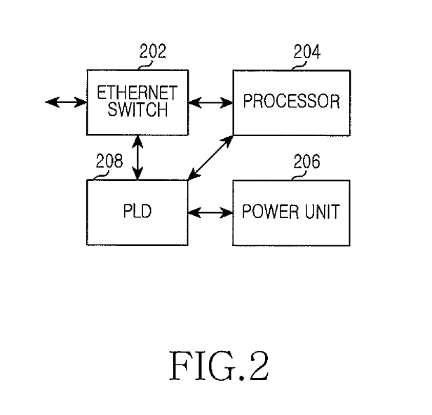

FIG. 2 illustrates a construction of a BS in a wireless communication system according to an exemplary embodiment of the present invention.

As illustrated in FIG. 2, the BS includes an Ethernet switch 202, a processor 204, a power unit 206, and a Programmable Logic Device (PLD) 208.

The Ethernet switch 202 is an interface for transmitting/receiving packets with other nodes through an Ethernet network. The Ethernet switch 202 sorts packets targeting the BS among packets forwarded through the Ethernet network and provides the packets to the processor 204. Also, according to the present invention, the Ethernet switch 202 checks an IP address of packets forwarded through the Ethernet network and a UDP port value. If the IP address is an IP address of the BS and the UDP port value is a UDP port number predefined for reset, the Ethernet switch 202 provides the corresponding packets to the PLD 208. That is, the Ethernet switch 202 sorts an Ethernet frame capable of including a power reset command, and provides the Ethernet frame to the PLD 208.

The processor 204 performs a control for operation of the BS. That is, during a normal operation, the processor 204 controls other blocks, and processes general data packets.

The power unit 206 takes charge of power supply to other blocks within the BS. Particularly, according to an exemplary embodiment of the present invention, if a power reset command is notified from the PLD 208, the power unit 206 cuts off all power sources within the BS and turns Off the BS and, after the lapse of a predetermined time, sequentially turns On necessary power sources of respective elements. However, because a block supplying a system clock from a Global Positioning System (GPS) of the BS or other synchronization source needs a learning time to keep holdover for a long time and consumes a long time in reoperation, the power unit 206 may not power Off the block supplying the system clock.

The PLD 208 identifies if a power reset command is generated using a packet provided from the Ethernet switch 202, that is, an Ethernet frame capable of including the power reset command. That is, the PLD 208 attempts to detect a reset pattern received from the external, and the PLD 208 determines the generation or non-generation of the power reset command depending on the detection result. And, in case that it is determined that the power reset command is generated, the PLD 208 notifies the power unit 206 to reset a power of the BS. At this time, the generation or non-generation of the power reset command is determined by whether reset pattern reception of ‘N’ times is performed within a predetermined time duration. The ‘N’ is an integer of ‘1’ or more and, for example, can be equal to ‘3’. That is, for exact judgment of a power reset command, a system sets the ‘N’ to an integer of ‘2’ or more. When a plurality of power reset commands are received within a predetermined time, the PLD 208 can determine that the power reset command is generated.

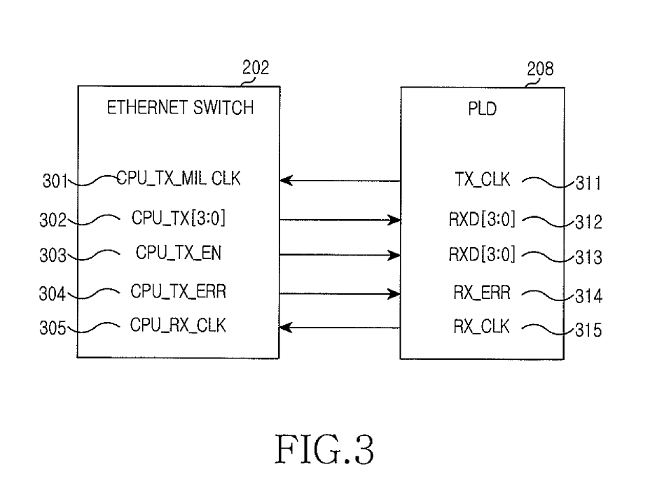

The PLD 208 forms Ethernet Media Independent Interface (MIT) connection with the Ethernet switch 202. More particularly, a connection relationship between the PLD 208 and the Ethernet switch 202 is shown as in FIG. 3. FIG. 3 illustrates a structure of connection between the Ethernet switch and the PLD in a wireless communication system according to an exemplary embodiment of the present invention. The PLD 208 only has to be able to perform a function of detecting a reset pattern, and does not have to transmit data to the Ethernet switch 202. Accordingly, because the PLD 208 only receives an Ethernet frame, only ports TX_CLK 311, RXD 312, RX_DV 313, RX_ERR 314, and RX_CLK 315 among ports of the PLD 208 are connected with ports CPU_TX_MIL CLK 301, CPU_TX 302, CPU_TX_EN 303, CPU_TX_ERR 304, and CPU_RX_CLK 305 of the Ethernet switch 202.

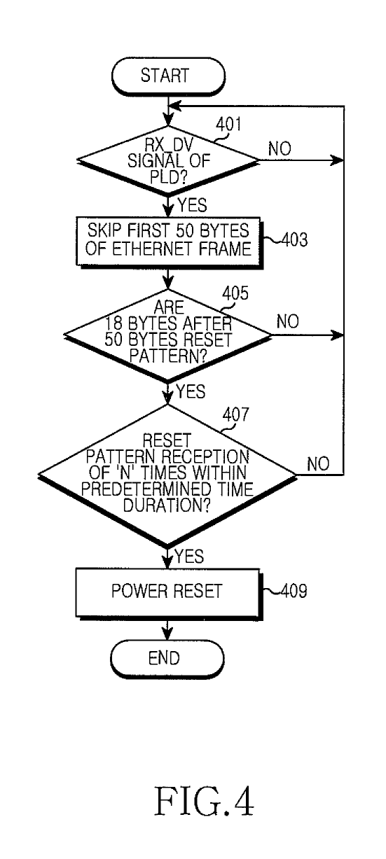

FIG. 4 illustrates a reset procedure of a BS in a wireless communication system according to an exemplary embodiment of the present invention.

Referring to FIG. 4, in block 401, the BS identifies if an RX_DV signal of a PLD is applied. That the RX_DV signal of the PLD is applied, that is, becomes active as ‘High’ means that an Ethernet switch within the BS intends to provide data to the PLD. In case that an Ethernet frame in which an IP address is an IP address of the BS and a UDP port value is a UDP port number predefined for reset is received, the Ethernet switch provides the Ethernet frame to the PLD. That is, in block 401, the BS identifies if the Ethernet frame in which the IP address is the IP address of the BS and the UDP port value is the UDP port number predefined for the reset is received.

If the RX_DV signal of the PLD is applied, the BS proceeds to block 403 and skips the first 50 bytes of the Ethernet frame. That is, because it is determined that the Ethernet frame is for a power reset command through the IP address and the UDP port value, the BS does not read the first 50 bytes, and attempts to detect a reset pattern located after the 50 bytes.

Next, the BS proceeds to block 405 and determines if information of 18 bytes after the 50 bytes is the reset pattern. The judgment as to whether the information is the reset pattern is carried out by the PLD within the BS. Here, it is described that the reset pattern is 18 bytes as one example. According to one embodiment, the reset pattern can be different in size. In some embodiments, a detailed value of the reset pattern can be different. If the information of the 18 bytes is not the reset pattern, the BS returns to block 401.

Alternatively, if the information of the 18 bytes is the reset pattern, the BS proceeds to block 407 and determines if reset pattern reception of ‘N’ times has been accomplished within a predetermined time duration. The ‘N’ is an integer of 1′ or more and, for example, can be equal to ‘3’. That is, for exact judgment of a power reset command, a system sets the ‘N’ to an integer of ‘2’ or more. In case that a plurality of power reset commands are received within a predetermined time, the BS can determine that a power reset command is generated. If the reset pattern reception of ‘N’ times within the predetermined time duration has not been accomplished, the BS returns to block 401.

Alternatively, if the reset pattern reception of ‘N’ times within the predetermined time duration has been accomplished, the BS proceeds to block 409 and performs power reset of the BS. That is, the power unit within the BS turns Off power sources for other blocks within the BS and, after the lapse of a predetermined time, sequentially turns On the power sources necessary for the blocks. At this time, power Off can be excluded for a block supplying a system clock.

Throughout the present invention, an operator can perform remote reset even in an abnormal situation of a main processor in a BS or system making use of Ethernet as a backhaul. By this, upon system malfunction, a service provider remotely resets a power of a BS, thereby being capable of reducing the number of times of visiting the BS and being capable of decreasing even a recovery time, thus being capable of achieving cost saving.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for use in a Base Station (BS) in a wireless communication system, the apparatus comprising:
an Ethernet switch configured to sort an Ethernet frame, the Ethernet frame capable of containing a power reset command;
a Programmable Logic Device (PLD) configured to detect a reset pattern at the Ethernet frame, and configured to determine the generation or non-generation of the power reset command depending upon the detection or non-detection of the reset pattern; and
a power unit configured to, if the generation of the power reset command is notified from the PLD, reset a power of a BS.

2. The apparatus of claim 1, wherein the Ethernet frame capable of containing the power reset command comprises an Ethernet frame comprising an Internet Protocol (IP) address of the BS and a User Datagram Protocol (UDP) port number predefined for the power reset.

3. The apparatus of claim 1, wherein the PLD is configured to skip a first 50 bytes of the Ethernet frame, and determine if a bit stream after the 50 bytes comprises the reset pattern.

4. The apparatus of claim 1, wherein, in case that reset pattern reception of the predefined number of times within a predetermined time duration is achieved, the PLD determines that the power reset command is generated.

5. The apparatus of claim 1, wherein the power unit turns Off power sources of other blocks within the BS and, after the lapse of a predetermined time, sequentially turns On the power sources of the other blocks.

6. The apparatus of claim 5, wherein the power unit turns Off power sources of the remaining blocks excepting a block supplying a system clock.

7. The apparatus of claim 1, wherein the Ethernet switch is configured to sort the Ethernet frame by sorting packets targeting the BS among packets forwarded through a Ethernet network and providing the packets to a processor, the processor configured to control operations within the BS.

8. An operation method of a Base Station (BS) in a wireless communication system, the method comprising:
sorting an Ethernet frame, the Ethernet frame capable of containing a power reset command;
detecting a reset pattern in the Ethernet frame;
determining the generation or non-generation of the power reset command based on the detection or non-detection of the reset pattern; and
if it is determined that the power reset command is generated, resetting a power of the BS.

9. The method of claim 8, wherein the Ethernet frame capable of comprising the power reset command comprises an Ethernet frame comprising an Internet Protocol (IP) address of the BS and a User Datagram Protocol (UDP) port number predefined for the power reset.

10. The method of claim 8, wherein detecting the reset pattern comprises:
skipping a first 50 bytes of the Ethernet frame; and
determining if a bit stream after the 50 bytes comprises the reset pattern.

11. The method of claim 8, wherein determining the generation or non-generation of the power reset command comprises determining that the power reset command is generated, in case that reset pattern reception of the predefined number of times within a predetermined time duration is achieved.

12. The method of claim 8, wherein resetting the power comprises:
turning Off power sources of other blocks within the BS; and
after the lapse of a predetermined time, sequentially turning On the power sources of the other blocks.

13. The method of claim 12, wherein turning Off the power sources of the other blocks within the BS comprises turning Off power sources of the remaining blocks excepting a block supplying a system clock.

14. A Base Station (BS) in a wireless communication system, the base station comprising:
a processor configured to control operation of the base station;
an Ethernet switch configured to sort an Ethernet frame, the Ethernet frame capable of containing a power reset command;
a Programmable Logic Device (PLD) configured to detect a reset pattern at the Ethernet frame, and configured to determine the generation or non-generation of the power reset command depending upon the detection or non-detection of the reset pattern; and
a power unit configured to, if the generation of the power reset command is notified from the PLD, reset a power of a BS.

15. The BS of claim 14, wherein the Ethernet frame capable of containing the power reset command comprises an Ethernet frame comprising an Internet Protocol (IP) address of the BS and a User Datagram Protocol (UDP) port number predefined for the power reset.

16. The BS of claim 14, wherein the PLD is configured to skip a first 50 bytes of the Ethernet frame, and determine if a bit stream after the 50 bytes comprises the reset pattern.

17. The BS of claim 14, wherein, in case that reset pattern reception of the predefined number of times within a predetermined time duration is achieved, the PLD determines that the power reset command is generated.

18. The BS of claim 14, wherein the power unit turns Off power sources of other blocks within the BS and, after the lapse of a predetermined time, sequentially turns On the power sources of the other blocks.

19. The BS of claim 18, wherein the power unit turns Off power sources of the remaining blocks excepting a block supplying a system clock.

20. The BS of claim 14, wherein the Ethernet switch is configured to sort the Ethernet frame by sorting packets targeting the BS among packets forwarded through a Ethernet network and providing the packets to the processor
